(19) United States
(12) Patent Application Publication
(10) Pub. No.: US 2016/0180234 A1
(43) Pub. Date: Jun. 23, 2016

(54) USING MACHINE LEARNING TO PREDICT PERFORMANCE OF AN INDIVIDUAL IN A ROLE BASED ON CHARACTERISTICS OF THE INDIVIDUAL

(71) Applicant: INSIDESALES.COM, INC., Provo, UT (US)

(72) Inventors: James Leslie Siebach, Corsica, PA (US); Jeffrey Berry, South Jordan, UT (US)

(21) Appl. No.: 14/581,837

(22) Filed: Dec. 23, 2014

(51) Int. Cl. G06N 5/04; G06N 99/00; G06Q 10/10

(52) U.S. Cl. CPC G06N 5/048; G06Q 10/1053; G06N 99/005

(57) ABSTRACT

Using machine learning to predict performance of an individual in a role based on characteristics of the individual. In one example embodiment, a method for using machine learning to predict performance of an individual in a role based on characteristics of the individual may include identifying the role, identifying the individual, identifying a target performance metric for the role, identifying the characteristics of the individual, and applying a machine learning classifier to generate a prediction of the individual achieving the target performance metric in the role. In this example embodiment, the machine learning classifier may base the prediction on the characteristics of the individual.

### FIELD

The embodiments discussed herein are related to using machine learning to predict performance of an individual in a role based on characteristics of the individual.

### BACKGROUND

One of the most important tasks for any organization is hiring. Hiring refers to selecting suitable candidates for employment in paid positions or unpaid positions within an organization. One main challenge faced by hiring personnel within an organization is predicting whether a candidate will perform adequately if employed in a position within the organization.

For example, an organization may desire to hire candidates into several sales positions within the business. Hiring personnel within the organization may follow a typical hiring process of screening resumes or curricula vitae and information on job application, holding job interviews with the candidates, and using all gathered information to predict whether each candidate will perform adequately in the sales position within the organization, and then hiring those candidates whom the hiring personnel predict will perform adequately in the sales position.

Unfortunately, however, this typical hiring process often results in hiring employees who reflect the Pareto Principle, namely, that 20% of the sales employees produce 80% of the sales for the organization, resulting in the other 80% of the sales employees producing only 20% of the sales for the organization. Thus, a typical hiring process may result in 80% of the new sales employees failing to perform adequately in their role within the organization. Since hiring an employee necessarily incurs expenses, such as equipment, training, and accounting expenses, hiring a new employee who fails to perform adequately in the employee's position may result in devastating financial consequences for the organization.

The subject matter claimed herein is not limited to embodiments that solve any disadvantages or that operate only in environments such as those described above. Rather, this background is only provided to illustrate one example technology area where some embodiments described herein may be practiced.

### SUMMARY

In general, example embodiments described herein relate to using machine learning to predict performance of an individual in a role based on characteristics of the individual. The example methods disclosed herein may identify an individual, identify a role, identify a target performance metric for the individual in the role, identify the characteristics of the individual, and then apply a machine learning classifier to generate a prediction of the individual achieving the target performance metric in the role based on the characteristics of the individual. In this manner, machine learning may be applied to predict the future performance of an individual, which may then be used, potentially in conjunction with other criteria, to inform a decision on whether to employ the individual in the role.

In one example embodiment, a method for using machine learning to predict performance of an individual in a role based on characteristics of the individual may include identifying the role, identifying the individual, identifying a target performance metric for the role, identifying the characteristics of the individual, and applying a machine learning classifier to generate a prediction of the individual achieving the target performance metric in the role. In this example embodiment, the machine learning classifier may base the prediction on the characteristics of the individual.

In another example embodiment, a method for using machine learning to predict performance of a candidate in a position in an organization based on dispositions of the candidate may include identifying the candidate, identifying the position in the organization, identifying a target performance metric for the position, identifying the dispositions of the candidate, and applying a machine learning classifier to generate a prediction of the candidate achieving the target performance metric in the position. In this example embodiment, the machine learning classifier may base the prediction on the dispositions of the candidate.

In yet another example embodiment, a method for using machine learning to predict performance of a candidate in a sales position in an organization based on dispositions of the candidate may include identifying the candidate, identifying the sales position in the organization, identifying a target sales quota for the sales position, administering a survey to the candidate, analyzing responses of the candidate on the survey to determine numerical values for the dispositions of the candidate, and applying a machine learning classifier to generate a prediction of a percentage of the target sales quota that the candidate will achieve in the sales position. In this example embodiment, the dispositions of the candidate may include ambition, empathy, openness, or resilience, or some combination thereof and the machine learning classifier may base the prediction on the numerical values for the dispositions of the candidate.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a schematic block diagram illustrating an example performance prediction system;

FIG. 2 is a schematic flowchart diagram illustrating example characteristic information being employed in the training of an example multilayer perceptron (MLP) neural network classifier and the subsequent generation of performance predictions by the MLP neural network classifier;

FIG. 3 is a schematic flowchart diagram of an example method for using machine learning to predict performance of an individual in a role based on characteristics of the individual;

FIGS. 4A and 4B illustrate an example graphical user interface (GUI) configured to display characteristics and performance of one or more individuals in one or more roles; and

FIG. 5 illustrates an example GUI configured to display predicted performances and actual performances of individuals in one or more roles.

### DESCRIPTION OF EMBODIMENTS

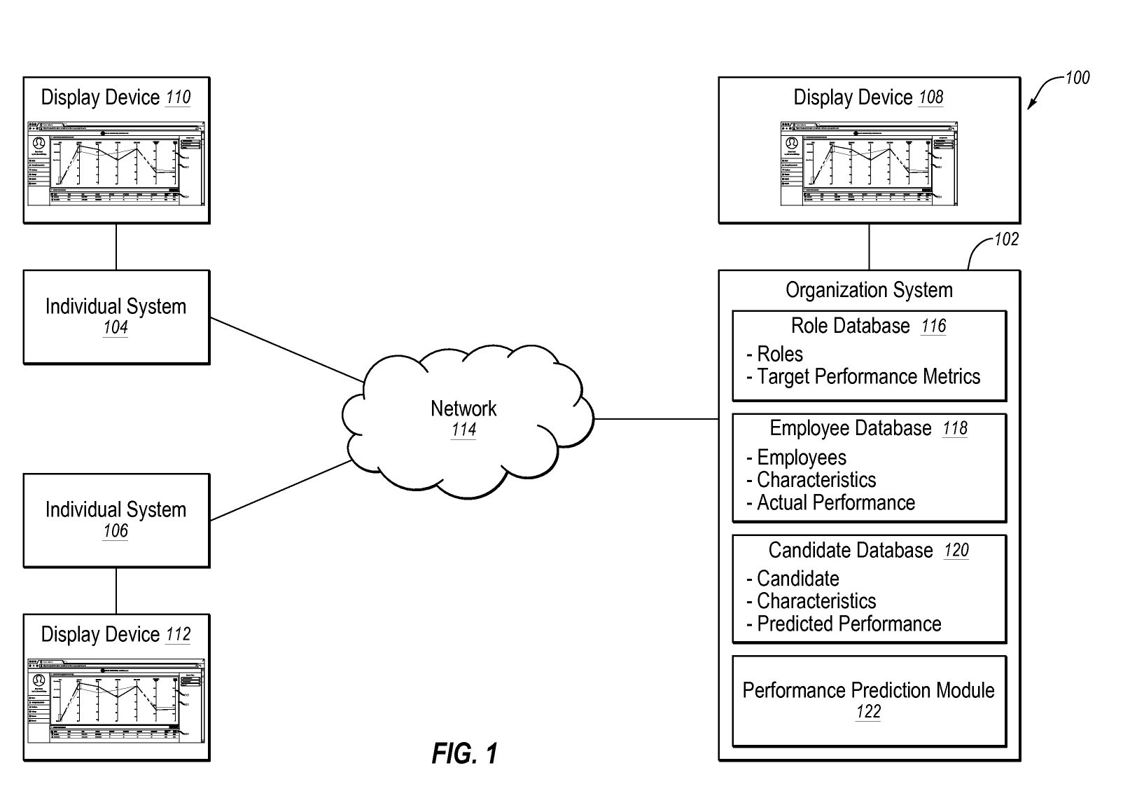

FIG. 1 is a schematic block diagram illustrating an example performance prediction system 100. As disclosed in FIG. 1, the system 100 may include an organization system 102 and individual systems 104 and 106. The organization system 102 may include a display device 108 and the individual systems 104 and 106 may include display devices 110 and 112, respectively. The systems 102, 104, and 106 may be configured to communicate with one another over a network 114.

Each of the systems 102, 104, and 106 may be any computing system capable of supporting a display device and capable of communicating with other systems including, for example, file servers, web servers, personal computers, desktop computers, laptop computers, handheld devices, multiprocessor systems, microprocessor-based or programmable consumer electronics, smartphones, digital cameras, hard disk drives, flash memory drives, virtual machines, or some combination thereof. Each of the display devices 108, 110, and 112 may be any type of display device capable of visually presenting a graphical user interface (GUI) to a user, such as a cathode ray tube (CRT) display, a light-emitting diode (LED) display, an electroluminescent display (ELD), a plasma display panel (PDP), a liquid crystal display (LCD), or an organic light-emitting diode display (OLED). In addition, any of the display devices 108, 110, and 112 may be a touchscreen implementation of any electronic display device, including the example electronic display devices listed above. The network 114 may be any wired or wireless communication network including, for example, a Local Area Network (LAN), a Metropolitan Area Network (MAN), a Wide Area Network (WAN), a Wireless Application Protocol (WAP) network, a Bluetooth network, an Internet Protocol (IP) network such as the internet, or some combination thereof. The network 114 may also be a network emulation of the hypervisor of a virtual machine over which one or more virtual machines may communicate.

As disclosed in FIG. 1, the organization system 102 may include a role database 116, an employee database 118, a candidate database 120, and a performance prediction module 122. The role database 116 may include information regarding roles, such as employment positions, within the organization of the organization system 102 as well as target performance metrics for the employee roles, such as target performance quotas. The employee database 118 may include identifying or demographic information regarding employees of the organization, characteristics of the employees, and actual performance of the employees within their respective roles within the organization. Similarly, the candidate database 120 may include identifying or demographic information regarding candidates, characteristics of the candidates, and predicted performance of the candidates within prospective roles within the organization.

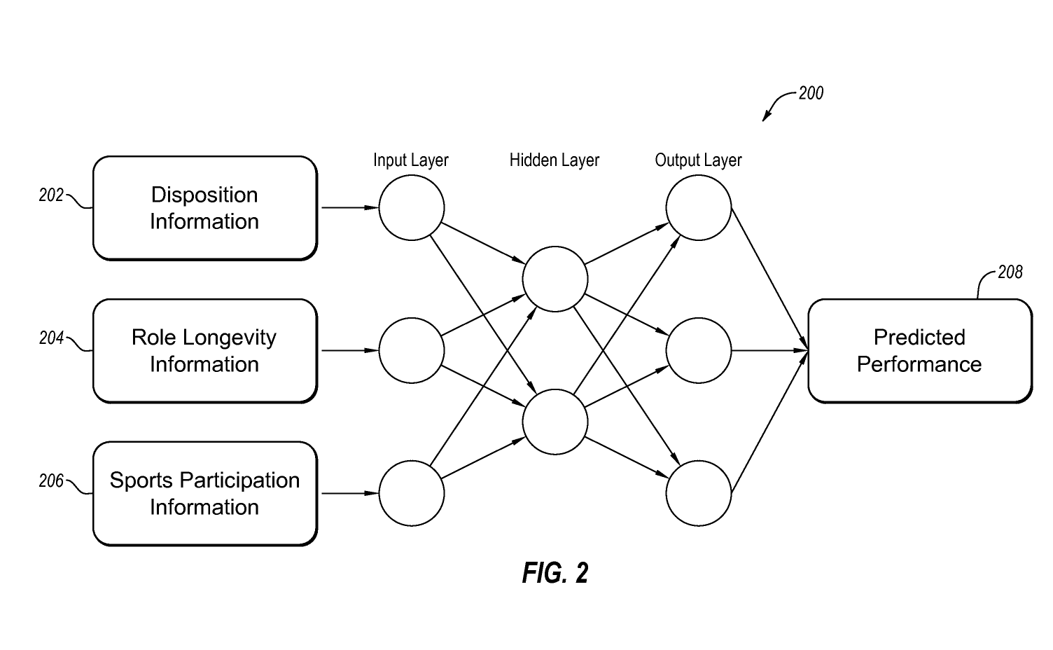

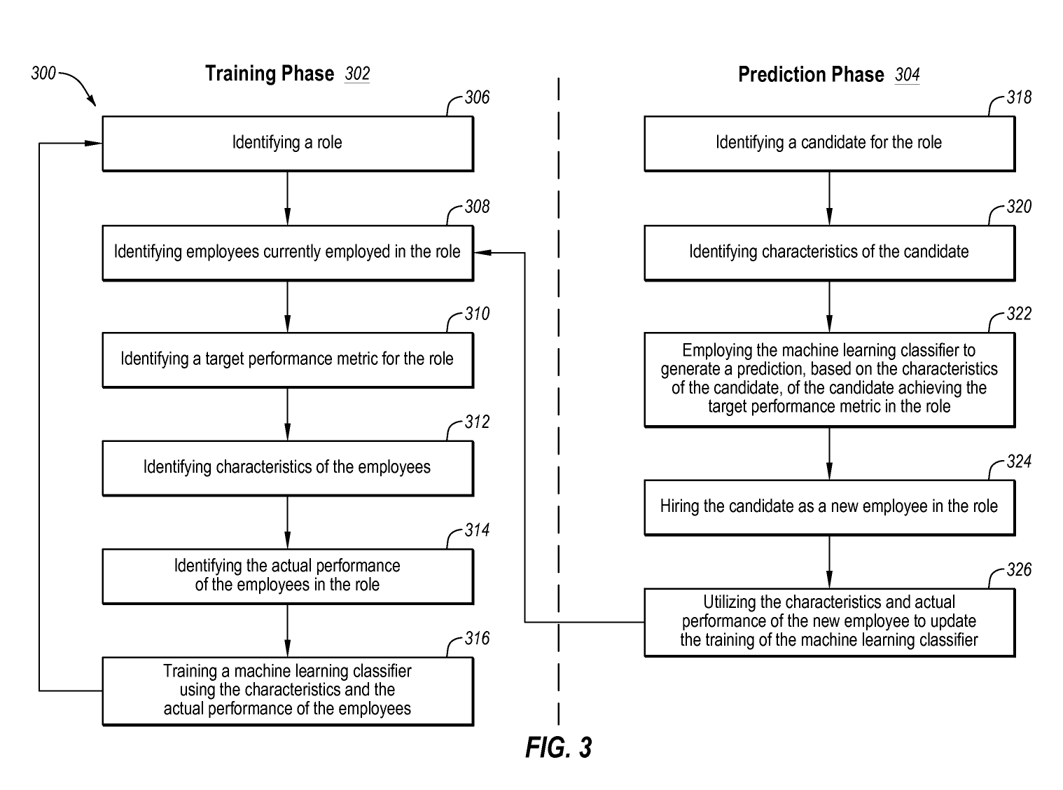

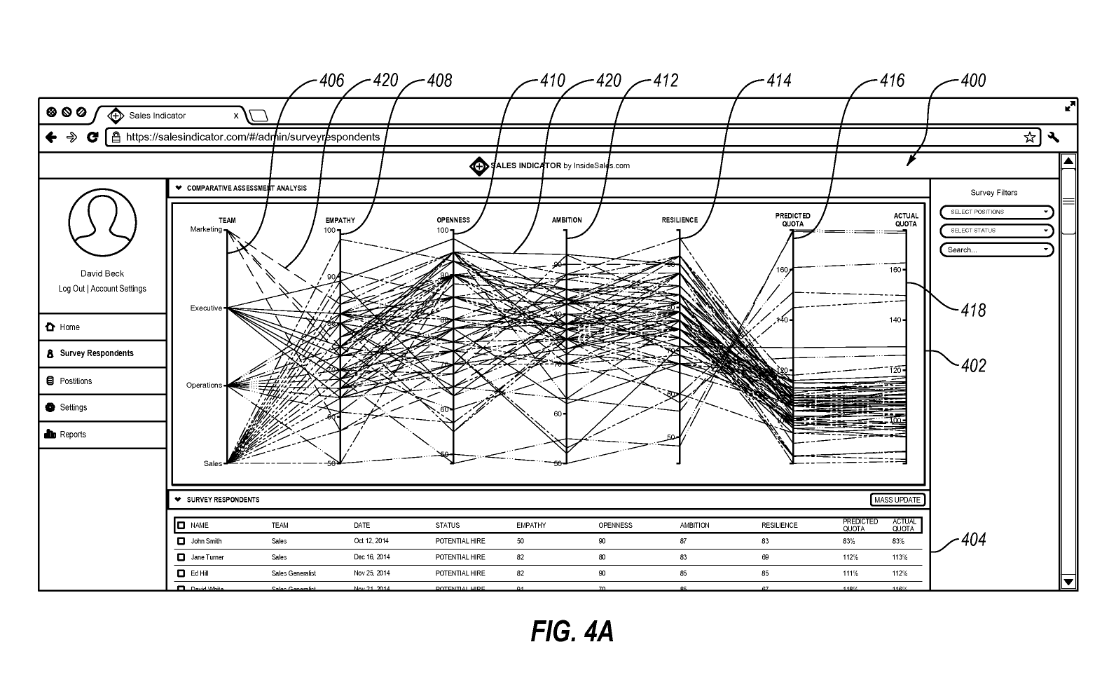

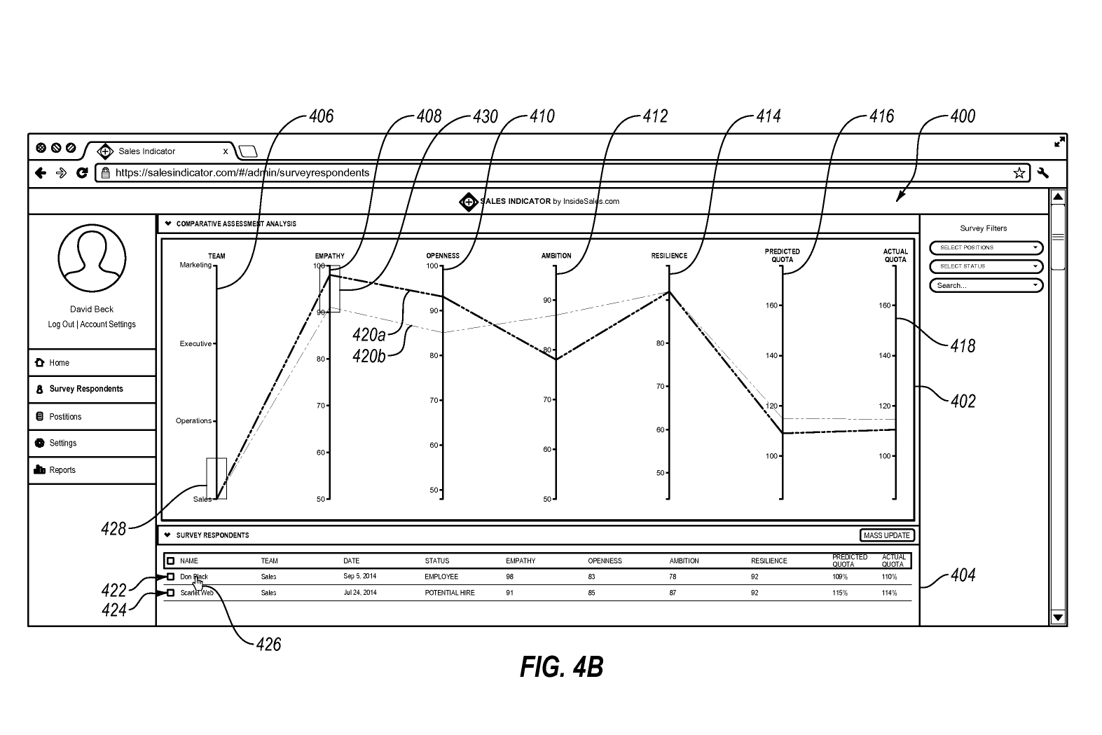

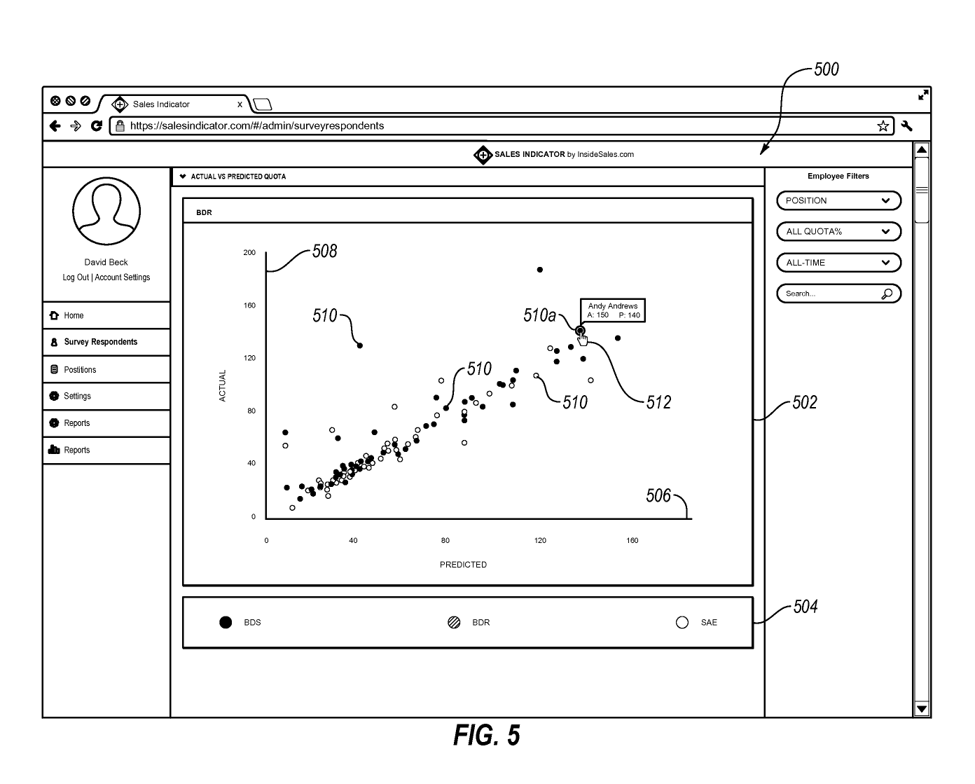

The performance prediction module 122 may gather information from users of the organization system 102 and/or from users of the individual systems 104 and 106, via the display devices 108, 110, and 112 for example, or gather information from other users or systems, and store this information in the databases 116, 118, and 120. Further, the performance prediction module 122 may use machine learning to predict performance of an individual in a role based on the information stored in the databases 116, 118, and 120, and store this predicted performance in the database 120, as discussed in greater detail below in connection with FIGS. 2 and 3. Also, the performance prediction module 122 may display various information that is stored in the databases 116, 118, and 120 on GUIs on the display devices 108, 110, and 112, as discussed in greater detail below in connection with FIGS. 4A, 4B, and 5.

Having described one specific environment with respect to FIG. 1, it is understood that the specific environment of FIG. 1 is only one of countless environments in which the example methods and GUIs disclosed herein may be practiced. The scope of the example embodiments is not intended to be limited to any particular environment.

FIG. 2 is a schematic flowchart diagram illustrating example characteristic information being employed in the training of an example multilayer perceptron (MLP) neural network classifier 200 and the subsequent generation of performance predictions by the classifier 200. As disclosed in FIG. 2, the classifier 200 may be trained using a variety of different characteristic information including, but not limited to, disposition information 202, role longevity information 204, and sports participation information 206. Then, after being trained, the classifier 200 may then be applied to generate a predicted performance 208 of an individual in a role.

For example, employees of the organization associated with the organization system 102 of FIG. 1 may take surveys using the display device 108 of the organization system 102. These surveys may be online surveys that include a series of questions which may be answered according to a Likert scale (e.g., 1. Strongly disagree, 2. Disagree, 3. Neither agree nor disagree, 4. Agree, or 5. Strongly agree) as well as other questions which may be answered with specific numbers representing specific units. These surveys may be configured to gather the disposition information 202 including, but not limited to, information related to particular dispositions, such as ambition, empathy, openness, resilience, culture, communication skills, experience, loyalty, happiness, cognitive ability, trustworthiness, social intelligence, emotional intelligence, depression, courage, fortitude, self-restraint, impulsivity, leadership, helpfulness, friendliness, courtesy, kindness, obedience, cheerfulness, thriftiness, bravery, cleanliness, and reverence. Responses on the surveys may then be analyzed to determine numerical values for the dispositions of the employees. These surveys may also be configured to gather the role longevity information 204 including, but not limited to, information related to past longevity of the employees, in terms of a specific unit of time such as months, in their current positions in the organization, or in equivalent positions at another organization. These surveys may also be configured to gather the sports participation information 206 including, but not limited to, information related to the employees' past participation in competitive sports, such as the number of months that each employee has spent competing in a particular sport. The employees' actual performance in their roles in the organization, in terms of target performance metrics for particular positions within the organization, may also be tracked and measured over time. This employee characteristic information 202, 204, and 206, as well as the actual performance of the employees, may then be stored in the employee database 118. These stored characteristics and actual performance of the employees may then be utilized to train the classifier 200.

Subsequently, candidates of the organization associated with the organization system 102 of FIG. 1 may take similar online surveys using the display devices 110 and 112 of the individual systems 104 and 106 that gather the disposition information 202, the role longevity information 204, and the sports participation information 206 of the candidates. This information 202, 204, and 206 may then be stored in the candidate database 120. The classifier 200 may then be applied to generate a predication of a particular candidate achieving the target performance metric associated with a particular position, as stored in the role database 116.

Therefore, the classifier 200 may be applied to predict the future performance of a candidate in a position within an organization, which may then be used to inform a decision by the organization on whether to employ the individual in the position. Although the classifier 200 is a multi-layer perceptron neural network used as a baseline machine learning model in FIG. 2, other machine learning classifiers may also be used in the example methods disclosed herein, including other multilayer neural network classifiers, decision tree classifiers, or support vector machine classifiers.

FIG. 3 is a schematic flowchart diagram of an example method 300 for using machine learning to predict performance of an individual in a role based on characteristics of the individual. The method 300 may be implemented, in at least some embodiments, by the performance prediction module 122 of the organization system 102 of FIG. 1. For example, the performance prediction module 122 may be configured as one or more non-transitory computer-readable media storing one or more programs that are configured, when executed, to cause one or more processors to perform the method 300, as represented by one or more of phases 302-304 and steps 306-326 of the method 300. Although illustrated as discrete phases and steps, various phases or steps may be divided into additional phases or steps, combined into fewer phases or steps, or eliminated, depending on the desired implementation. The training phase 302 and the prediction phase 304 of the method 300 will now be discussed with reference to FIGS. 1-3.

The training phase 302 of the method 300 may include step 306 of identifying a role. For example, the performance prediction module 122 of FIG. 1 may identify, at step 306, a role stored in the role database 116, which may be a position within the organization associated with the organization system 102 such as a sales position. Example sales positions include, but are not limited to, business development specialist (BDS) positions, business development representative (BDR) positions, and sales account executive (SAE) positions. Other example positions include, but are not limited to, marketing positions, executive positions, and operations positions.

The training phase 302 of the method 300 may include step 308 of identifying employees currently employed in the role. Continuing with the above example, the performance prediction module 122 of FIG. 1 may identify, at step 308, employees whose information is stored in the employee database 118 and who are currently employed in the sales position that was identified at step 306.

The training phase 302 of the method 300 may include step 310 of identifying a target performance metric for the role. Continuing with the above example, the performance prediction module 122 of FIG. 1 may identify, at step 310, a target performance metric stored in the role database 116 for the sales position, which may be target sales quota for the sales position.

The training phase 302 of the method 300 may include step 312 of identifying characteristics of the employees. Continuing with the above example, the performance prediction module 122 of FIG. 1 may identify, at step 312, characteristics stored in the employee database 118 for the employees that were identified at step 308. As noted elsewhere herein, these characteristics may be gathered by administering a survey to the employees and then analyzing employee responses on the survey to determine numerical values for these characteristics. As noted elsewhere herein, these characteristics may include, but are not limited to, dispositions of the employees, role longevity of the employees, and sports participation of the employees. It is understood that characteristics that are particularly relevant to the role identified at step 306 may be among the characteristics that are identified at step 312. For example, it has been determined that the characteristics that are particularly relevant to an employee's performance in a sales position are the employee's dispositions of ambition, empathy, openness, and resilience; the employee's longevity in an equivalent sales position; the employee's history of sports participation in a competitive sport such as wrestling; and the employee's history of participation in an altruistic activity. In addition, phonometric measurements, such as volume, cadence, and pitch of an employee's voice, may also be characteristics that are particularly relevant to an employee's performance in a sales position.

The training phase 302 of the method 300 may include step 314 of identifying the actual performance of the employees in the role. Continuing with the above example, the performance prediction module 122 of FIG. 1 may identify, at step 314, the actual percentages of the target sales quota achieved by the employees in the sales position, as stored in the employee database 118. For example, where a target sales quota is 30 sales per month, and a particular employee averages 39 sales per month, the employee's actual percentage of the target sales quota would be 130%.

The training phase 302 of the method 300 may include step 316 of training a machine learning classifier using the characteristics and the actual performance of the employees. Continuing with the above example, the performance prediction module 122 of FIG. 1 may train, at step 316, the 200 of FIG. 2 using the characteristics identified at step 312 and the actual performance identified at step 314. It is noted that the characteristics may be combined in various ways during the training phase in order to increase the number of inputs to the Classifier 200, using feature engineering processes. As a result, at the conclusion of the training phase 302, the Classifier 200 of FIG. 2 will be trained to accurately predict, during the prediction phase 304, the performance of a candidate in the role identified at step 306 based on characteristics of the candidate. The step 316 may further include a pre-training of a hidden layer of the Classifier 200 as a Denoising Autoencoder. Alternatively or additionally, the step 316 may include training the Classifier 200 using Stochastic Gradient Descent.

The prediction phase 304 of the method 300 may include step 318 of identifying a candidate for the role. Continuing with the above example, the performance prediction module 122 of FIG. 1 may identify, at step 318, a candidate, whose information is stored in the candidate database 120, for the sales position that was identified at step 306.

The prediction phase 304 of the method 300 may include step 320 of identifying characteristics of the candidate. Continuing with the above example, the performance prediction module 122 of FIG. 1 may identify, at step 320, characteristics stored in the candidate database 120 for the candidate that was identified at step 318. At least some of these characteristics may be the same characteristics that were identified at step 312 for the employees of the organization. Further, these characteristics may be gathered by administering, to the candidate, the same survey or a similar survey that was administered to the employees, and then analyzing the candidate's responses on the survey to determine numerical values for these characteristics.

The prediction phase 304 of the method 300 may include step 322 of applying a machine learning classifier to generate a prediction, based on the characteristics of the candidate, of the candidate achieving the target performance metric in the role. Continuing with the above example, the performance prediction module 122 of FIG. 1 may apply, at step 322, the Classifier 200 of FIG. 2, which was trained at step 316, to generate a prediction, based on the characteristics of the candidate, of a percentage of the target sales quota that the candidate will achieve in the sales position, based on the numerical values for the dispositions of the candidate. This prediction that is generated at step 322 may be useful in determining whether the candidate should be hired as an employee of the organization. For example, where this prediction at step 322 indicates that the candidate will not reach the target sales quota, the organization may opt not to hire the candidate. Conversely, where this prediction at step 322 indicates that the candidate will reach or exceed the target sales quota, the organization may opt to hire the candidate as an employee. As a result, by the step 322, the Classifier 200 of FIG. 2 may be applied to predict the future performance of an individual, which may then be used to inform a decision on whether to employ a candidate in a particular position within the organization.

The prediction phase 304 of the method 300 may include step 324 of hiring the candidate as a new employee in the role. Continuing with the above example, the performance prediction module 122 of FIG. 1 may hire, at step 324, the candidate as a new employee in the sales position. Step 324 may further include measuring the actual performance of the new employee in the sales position in terms of the target sales quota.

The prediction phase 304 of the method 300 may include step 326 of utilizing the characteristics and actual performance of the new employee to update the training of the machine learning classifier. Continuing with the above example, the performance prediction module 122 of FIG. 1 may utilize, at step 326, the characteristics and actual performance of the new employee to update the training of the Classifier 200 of FIG. 2 by, for example, repeating the steps 308-316 of the training phase 302 utilizing the characteristics and actual performance of the new employee, as disclosed by the arrow from step 326 to step 308 in FIG. 3. In this manner, the training of the Classifier 200 of FIG. 2 may be continually updated and improved with additional data over time as candidates are hired as employees. This continual updating and improvement of the training of the Classifier 200 of FIG. 2 may enable the Classifier 200 to generate increasingly accurate predictions of future performance of candidates, which may then be used to inform increasingly intelligent decisions on whether to employ candidates in particular positions in the organization.

Having described the example method 300 of using machine learning to predict performance of an individual in a role based on characteristics of the individual with respect to FIGS. 1-3, two example GUIs 400 and 500 that allow users to access and analyze data related to predicted and actual performance of candidates and employees will be described with respect to FIGS. 4A, 4B, and 5. It is understood that the specific GUIs 400 and 500 of FIGS. 4A, 4B, and 5 are only two of countless GUIs in which example embodiments may be employed. The scope of the example embodiments is not intended to be limited to any particular GUI.

FIGS. 4A and 4B illustrate an example GUI 400 configured to display characteristics and performance of one or more individuals in one or more roles. The GUI 400 represents a console of the Sales Indicator system produced by InsideSales.com in Provo, Utah.

The GUI 400 may be implemented by the performance prediction module 122 of the organization system 102 of FIG. 1. In particular, the GUI 400 may be implemented by the performance prediction module 122 as one or more non-transitory computer-readable media that store one or more programs that are configured, when executed, to cause one or more processors to identify one or more roles (as stored in the role database 116, for example), identify one or more individuals (whose information is stored in the employee database 118 and/or the candidate database 120, for example), identify one or more characteristics of the one or more individuals (as stored in the employee database 118 and/or the candidate database 120, for example), identify predicted and/or actual performances of the one or more individuals in the one or more roles (as stored in the employee database 118 and/or the candidate database 120, for example), and then generate and visually present, on the electronic display device 108 associated with the one or more processors, the GUI 400. As disclosed in FIGS. 4A and 4B, the GUI 400 may include a graph 402 and a list 404.

As disclosed in FIG. 4A, the graph 402 may include an axis 406 representing one or more roles, one or more axes 408, 410, 412, and 414 each representing characteristics of individuals, an axis 416 representing a predicted performance of individuals in the roles, and an axis 418 representing an actual performance of the individuals in the roles. The graph 402 may further include objects 420 (only two of which are labeled in FIG. 4A) positioned along and/or or running between the axes 406-418, with each object 420 corresponding to one of the individuals. It is noted that the axes 406-418 may be vertical axes, horizontal axes, or axes that are neither horizontal nor vertical such as diagonal axes.

For example, the objects 420, which may be lines, may each represent a survey respondent that is either a candidate or an employee of an organization, such as the organization associated with the organization system 102 of FIG. 1. The axis 406 may represent one or more positions within the organization, such as a marketing position, an executive position, an operations position, and a sales position within the organization. The axes 408, 410, 412, and 414 may represent numerical values for the dispositions of empathy, openness, ambition, and resilience, respectively, of the survey respondents. Other potential characteristics that other axes could represent include, but are not limited to, the other characteristics mentioned herein, including each of the characteristics mentioned in connection with FIG. 2. The axis 416 may represent percentages of target performance quotas that were predicted to be achieved by the survey respondents in the corresponding positions and the axis 418 may represent percentages of target performance quotas of the survey respondents that have actually been achieved in the corresponding positions. It is noted that the axis 418 may be included for employees but not for candidates since actual performance may not be available until after a candidate has been hired as an employee and has had time for the employee's performance to be tracked and measured.

As disclosed in FIGS. 4A and 4B, the list 404 may include one or more items. For example, as disclosed in FIG. 4B, the list 404 may include items 422 and 424 which correspond the survey respondents represented by the objects 420a and 420b, respectively, in the graph 402. The graph 402 may be configured, upon selection of one of the items in the list 404, such as the item 422, to visually highlight the object 420a corresponding to the survey respondent that corresponds to the selected item 422. This visual highlighting of the object 420a may include, but is not limited to, the bolding of the object 420a, as disclosed in FIG. 4B. The graph 402 may alternatively or additionally be configured, upon selection of one of the items in the list 404, such as the item 422, to visually deemphasize one or more other objects 420 in the graph 402, such as the object 420b, that do not correspond to the survey respondent that corresponds to the selected item 422. This visual deemphasis of the object 420b may include, but is not limited to, the lightening and/or thinning of the object 420b, as disclosed in FIG. 4B. This selection of the selected item 422 may include a user of the GUI 400 hovering a pointer 426 over the selected item 422, or over a particular portion of the selected item 422 such as a linked name of the survey respondent that is included in the selected item 422, as disclosed in FIG. 4B.

Also disclosed in FIG. 4B, each of the axes 406-418 may include a range filter that allows only those of the objects 420 that fall within a range of the range filter to be displayed in the graph 402. For example, the range filter 428 limits the objects 420 displayed in the graph 402 to objects that correspond to survey respondents in the sales position in the organization, and the range filter 430 limits the objects 420 displayed in the graph 402 to objects that correspond to survey respondents having an empathy numerical value between 90 and 100. Thus, the range filters 428 and 430 may be employed to limit the number of survey respondents represented in the graph 402.

The GUI 400 of FIGS. 4A and 4B may therefore be employed to display characteristics and performances of one or more individuals in one or more roles. Where objects 420 representing multiple individuals are displayed simultaneously, the GUI 400 may allow a user to compare, and thus view similarities and differences between, different individuals both in terms of characteristics as well as performance.

FIG. 5 illustrates an example GUI 500 configured to display predicted performances and actual performances of individuals in one or more roles. Similar to the GUI 400 of FIGS. 4A and 4B, the GUI 500 of FIG. 5 represents a console of the Sales Indicator system produced by InsideSales.com.

The GUI 500 may be implemented by the performance prediction module 122 of the organization system 102 of FIG. 1. In particular, the GUI 500 may be implemented by the performance prediction module 122 as one or more non-transitory computer-readable media that store one or more programs that are configured, when executed, to cause one or more processors to identify individuals (whose information is stored in the employee database 118, for example), identify predicted performances of the individuals in one or more roles (as stored in the role database 116 and in the candidate database 120 for employees who were candidates prior to being hired, for example), identify actual performances of the individuals in the one or more roles (as stored in the role database 116 and in the employee database 118, for example), and then generate and visually present, on the electronic display device 108 associated with the one or more processors, the GUI 500. As disclosed in FIG. 5, the GUI 500 may include a graph 502 and a legend 504.

The graph 502 may include a first axis 506 representing predicted performances of individuals in one or more roles, a second axis 508 representing actual performances of the one or more individuals in the one or more roles, and objects 510 (only three of which are labeled in FIG. 5) positioned along the first axis 506 and the second axis 508 that each corresponds to one of the individuals. It is noted that the axes 506 and 508 may be vertical axes, horizontal axes, or axes that are neither horizontal nor vertical such as diagonal axes. The legend 504 may present a meaning for a color of each of the objects 510 in the graph 502.

For example, the objects 510, which may be dots, may each represent an individual that was once a candidate of an organization and is now an employee of the organization. A color of each of the objects 510 may represent a position corresponding to the object 510, as reflected in the three different sales positions listed in the legend 504. The colors presented in the legend may also include controls, such as radio button controls or checkbox controls, which enable any of the corresponding objects 510 to be hidden in the GUI 500. The first axis 506 may represent predicted percentages of target performance quotas of the individual in the corresponding positions and the second axis 508 may represent actual percentages of target performance quotas of the individuals in the corresponding positions.

As disclosed in FIG. 5, the graph 502 may be configured, upon selection of one of the objects 510, such as the object 510a, to visually present details regarding the individual corresponding to the selected object 510a and/or to visually highlight the selected object 510a. This visual presentation of details regarding the individual corresponding to the selected object 510a may include, but is not limited to, the individual's name (e.g. Andy Andrews), the individual's predicted percentage of the target performance quotas of the individual's position (e.g. 140%), and the individual's actual percentage of the target performance quotas of the employee's position (e.g. 150%), as disclosed in FIG. 5. Also disclosed in FIG. 5, the visual highlighting of the selected object 510a may include, but is not limited to, circling the selected object 510a. This selection of the selected object 510a may include, but is not limited to, a user of the GUI 500 hovering a pointer 512 over the selected object 510a.

The GUI 500 of FIG. 5 may therefore be employed to display predicted performances and actual performances of individuals in one or more roles. Where objects 510 representing multiple individuals are displayed simultaneously, the GUI 500 may allow a user to easily detect whether the predicted performances and the actual performances generally match, which is the case where the objects 510 generally fall in a trendline that resembles an identity line (i.e., a 1:1 correlation between the axes 506 and 508), which may give the user confidence that a predicted performance of a candidate will accurately reflect the measured actual performance once the candidate is hired as an employee, thus increasing confidence in future performance predictions made by the Classifier 200 of FIG. 2.

Although example embodiments are discussed above in connection with candidates of an organization and employees of the organization who are employed in a particular position within the organization, it is understood that other example embodiments may be implemented in connection with any individual in any role, whether or not that role is specific to a particular organization. For example, some example embodiments may be implemented to predict the performance of an individual guide dog in the role of guiding a person who is blind based on characteristics (including dispositions) of the individual guide dog. Therefore, example embodiments are not limited to candidates and employees, but also include other individuals (including human individuals, animal individuals, and other individuals) for whom predicted performance in a future role based on characteristics of the individuals, in terms of a target performance metric for the role, is desired. It is further understood that employment within an organization includes both paid employment as well as unpaid employment such as unpaid internships.

The embodiments described herein may include the use of a special-purpose or general-purpose computer, including various computer hardware or software modules, as discussed in greater detail below.

Embodiments described herein may be implemented using non-transitory computer-readable media for carrying or having computer-executable instructions or data structures stored thereon. Such computer-readable media may be any available media that may be accessed by a general-purpose or special-purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other storage medium which may be used to carry or store one or more desired programs having program code in the form of computer-executable instructions or data structures and which may be accessed and executed by a general-purpose computer, special-purpose computer, or virtual computer such as a virtual machine. Combinations of the above may also be included within the scope of computer-readable media.

Computer-executable instructions comprise, for example, instructions and data which, when executed by one or more processors, cause a general-purpose computer, special-purpose computer, or virtual computer such as a virtual machine to perform a certain method, function, or group of methods or functions. Although the subject matter has been described in language specific to structural features and/or methodological steps, it is to be understood that the subject matter defined in the appended claims is not necessarily limited to the specific features or steps described above. Rather, the specific features and steps described above are disclosed as example forms of implementing the claims.

As used herein, the term “module” may refer to software objects or routines that execute on a computing system. The different modules described herein may be implemented as objects or processes that execute on a computing system (e.g., as separate threads). While the system and methods described herein are preferably implemented in software, implementations in hardware or a combination of software and hardware are also possible and contemplated.

All examples and conditional language recited herein are intended for pedagogical objects to aid the reader in understanding the example embodiments and the concepts contributed by the inventor to furthering the art, and are to be construed as being without limitation to such specifically recited examples and conditions.

1. A method for using machine learning to predict performance of an individual in a role based on characteristics of the individual, the method comprising:
identifying the role;
identifying the individual;
identifying a target performance metric for the role;
identifying the characteristics of the individual;
applying a machine learning classifier to generate a prediction of the individual achieving the target performance metric in the role prior to measuring performance of the individual in the role, the machine learning classifier basing the prediction on the characteristics of the individual;
generating and visually presenting, on an electronic display device, an interactive graphical user interface (GUI) graph configured to display the predicted performance of the individual in the role, the interactive GUI graph including:
a first axis representing the prediction of the individual achieving the target performance metric in the role; and
an object positioned along the first axis that corresponds to the individual; and
in response to a selection on the interactive GUI graph by a user, visually highlighting the object.

2-9. (canceled)

10. One or more tangible non-transitory computer-readable media, not including a signal, storing one or more programs that are configured, when executed, to cause one or more processors to perform the method as recited in claim 1.

11-15. (canceled)

16. A method for using machine learning to predict performance of a candidate in a sales position in an organization based on dispositions of the candidate, the method comprising:
identifying the sales position in the organization;
identifying employees currently employed in the sales position in the organization;
identifying a target sales quota for the sales position;
administering surveys to the employees;
analyzing responses of the employees on the survey to determine numerical values for dispositions of the employees, the dispositions of the employees including ambition, empathy, openness, or resilience, or some combination thereof;
identifying actual percentages of the target sales quota that the employees have achieved in the sales position;
training a machine learning classifier using the dispositions of the employees and the actual percentages of the target sales quota that the employees have achieved in the sales position;
identifying the candidate;
administering a survey to the candidate;
analyzing responses of the candidate on the survey to determine numerical values for the dispositions of the candidate, the dispositions of the candidate including ambition, empathy, openness, or resilience, or some combination thereof;
applying the machine learning classifier to generate a prediction of a percentage of the target sales quota that the candidate will achieve in the sales position, the machine learning classifier basing the prediction on the numerical values for the dispositions of the candidate;
hiring the candidate as a hired employee in the sales position;
measuring an actual percentage of the target sales quota that the hired employee has achieved in the sales position;
utilizing the numerical values for the dispositions of the hired employee and the measured actual percentage of the target sales quota that the hired employee has achieved in the sales position to update the training of the machine learning classifier;
generating and visually presenting, on an electronic display device, an interactive graphical user interface (GUI) graph configured to display the predicted and actual performance of the employees in the sales position, the interactive GUI graph including:
a first axis representing the predicted percentage of the target sales quota that the employees would achieve in the sales position;
a second axis representing the measured actual percentage of the target sales quota that the employees have achieved in the sales position; and
objects positioned along the first and second axes, each of the objects corresponding to one of the employees; and
in response to a selection on the interactive GUI graph by a user, visually highlighting one of the objects.

17-18. (canceled)

19. The method of claim 16, wherein:
the machine learning classifier is a multilayer perceptron (MLP) neural network;
the method further comprises pre-training a hidden layer of the MLP neural network as a Denoising Autoencoder; and
the method further comprises training the MLP neural network using Stochastic Gradient Descent.

20. One or more tangible non-transitory computer-readable media, not including a signal, storing one or more programs that are configured, when executed, to cause one or more processors to perform the method as recited in claim 16.

21-24. (canceled)

25. The method of claim 1, wherein:
the interactive GUI graph further includes a second axis representing the role;
the interactive GUI graph further includes one or more third axes each representing one of the characteristics of the individual;
the object is a line that is positioned along and runs between the first, second, and third axes;
the interactive GUI graph further includes a list of items that is not positioned along the first, second, and third axes;
a first one of the items in the list corresponds to the individual; and
the selection on the interactive GUI graph by the user includes selection of the first one of the items in the list by the user.

26. The method of claim 25, wherein:
the method further comprises identifying an actual achievement of the target performance metric by the individual in the role;
the interactive GUI graph further includes a fourth axis representing the actual achievement of the target performance metric by the individual in the role; and
the line is positioned along and runs between the first, second, third and fourth axes.

27. The method of claim 26, wherein:
each of the first, second, third, and fourth axes includes a range filter that allows only line(s) that fall within a range of the range filter to be displayed in the interactive GUI graph.

28. The method of claim 26, wherein:
the first, second, third, and fourth axes are parallel vertical axes.

29. The method of claim 1, wherein:
the interactive GUI graph further includes a second axis representing an actual achievement of the target performance metric by the individual in the role;
the object is positioned along the first and second axes;
the selection on the interactive GUI graph by the user includes selection of the object by the user; and
the method further comprises, in response to selection of the object by the user, visually presenting details regarding the individual corresponding to the selected object.

30. The method of claim 29, wherein:
the first axis is a horizontal axis;
the second axis is a vertical axis; and
the object is a dot.

31. The method of claim 30, wherein:
a color of the dot the role; and
the interactive GUI graph further includes a legend which presents a meaning for the color.

32. The method of claim 16, wherein:
the interactive GUI graph further includes a third axis representing the sales position;
the interactive GUI graph further includes one or more fourth axes each representing one of the dispositions of the employees;
the objects are lines that are positioned along and run between the first, second, third, and fourth axes;
the interactive GUI graph further includes a list of items not positioned along the first, second, third, and fourth axes;
a first one of the items in the list corresponds to the hired employee;
the selection on the interactive GUI graph by the user includes selection of the first one of the items in the list; and
the visually highlighted line corresponds to the hired employee.

33. The method of claim 32, wherein:
each of the first, second, third, and fourth axes includes a range filter that allows only those lines that fall within a range of the range filter to be displayed in the interactive GUI graph.

34. The method of claim 32, wherein:
the first, second, third, and fourth axes are parallel vertical axes.

35. The method of claim 32, wherein:
the selection of the selected item includes hovering over the selected item.

36. The method of claim 16, wherein:
the selection on the interactive GUI graph by the user includes selection of the selected object by the user; and
the method further comprises, in response to the selection of the selected object by the user, visually presenting details regarding the employee corresponding to the selected object.

37. The method of claim 36, wherein:
the first axis is a horizontal axis;
the second axis is a vertical axis; and
the objects are dots.

38. The method of claim 37, wherein:
colors of the dots represent different positions in the organizations;
the interactive GUI graph further includes a legend which presents meanings for the colors; and
the colors presented in the legend include controls that enable any corresponding dots to be hidden in the interactive GUI graph.

39. The method of claim 37, wherein:
the details regarding the employee corresponding to the selected object include the employee's name, the employee's predicted percentage of the target sales quota of the employee's sales position, and the employee's actual percentage of the target sales quota of the employee's sales position.
